(19) United States
(12) Patent Application Publication
(10) Pub. No.: US 2014/0073742 A1
(43) Pub. Date: Mar. 13, 2014

(54) UNSATURATED POLYESTER RESIN COMPOSITION

(71) Applicants: Johan Franz Gradus Antonius Jansen, Echt (NL); Iris Hilker, Echt (NL); Nanning Joerg Arfsten, Echt (NL)

(72) Inventors: Johan Franz Gradus Antonius Jansen, Echt (NL); Iris Hilker, Echt (NL); Nanning Joerg Arfsten, Echt (NL)

(73) Assignee: DSM IP ASSETS B.V., Heerlen (NL)

(21) Appl. No.: 14/008,385

(22) PCT Filed: Mar. 29, 2012
(86) PCT No.: PCT/EP12/55670

§ 371 Date: Nov. 18, 2013

(30) Foreign Application Priority Data
Mar. 30, 2011 (EP) 11160438.5
Feb. 20, 2012 (EP) 12156140.1

(51) Int. Cl. C08F 283/01; C08K 5/14

(52) U.S. Cl. CPC C08F 283/01; C08K 5/14
USPC 525/263; 525/284; 525/242

(57) ABSTRACT

The present invention relates to unsaturated polyester resin compositions comprising (a) an unsaturated polyester, (b) a vinyl group containing organic compound as reactive diluent and (c) a tertiary aromatic amine, wherein the resin composition further comprises (d) a compound according to formula (1) as reactive diluent

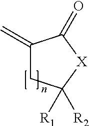

whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain or attached to a polymer chain,
and the resin composition comprises, as vinyl group containing organic compound (b), styrene, a styrene derivative, a vinyl ether, a vinyl amine or vinyl amide or a mixture of at least two of these compounds.

The present invention relates to an unsaturated polyester resin composition comprising (a) an unsaturated polyester, (b) a vinyl group containing organic compound as reactive diluent and (c) a tertiary aromatic amine.

Such unsaturated polyester resin compositions are known in the art. For example, a composition comprising an unsaturated polyester diluted in styrene as reactive diluent and pre-accelerated with a tertiary aromatic amine can be efficiently radical copolymerized (cured) with a peranhydride. Styrene is often used as reactive diluent. Although styrene is a very effective reactive diluent, since styrene has a high copolymerization ability and a good cutting power (viscosity of the composition can be lowered efficiently when using styrene as comonomer), styrene has however an undesirable odour which is even more hindering since styrene is volatile. In view of this, there is a need to at least partly replace styrene by another reactive diluent with a good reactivity and good cutting power, but has less odour and/or is less volatile (i.e. has a higher boiling point). A standard replacement would be the use of high boiling methacrylate containing compounds. However, in general they have a reduced cutting power and furthermore they result in general in severe oxygen inhibition, i.e. upon curing in air, the surface remains tacky or even wet (uncured).

The object of the present invention is to provide a reactive diluent with less odour and/or being less volatile and with a good cutting power in unsaturated polyester resin compositions.

The object has surprisingly achieved in that the resin composition further comprises (d) a compound according to formula (1) as reactive diluent

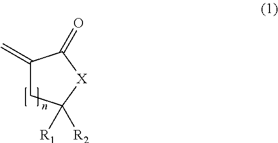

whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain or attached to a polymer chain,
and the resin composition comprises, as vinyl group containing organic compound (b), styrene, a styrene derivative, a vinyl ether, a vinyl amine or vinyl amide or a mixture of at least two of these compounds.

It has furthermore surprisingly been found that the reactive diluent according to formula (1) has a good copolymerization ability with the unsaturated polyester resin.

It has furthermore surprisingly been found that curing of the resin composition according to the invention with a peranhydride can result in a higher glass transition temperature (T_{g}) and/or higher crosslink density of the cured network and thus that an improved cured network can be obtained.

It has surprisingly been found that curing of the composition according to the invention in the presence of air can be improved, in particular the tackiness of the air surface can be reduced and even tack free surfaces can be obtained.

An additional advantage of using compounds according to formula (1) is that they can be prepared from biobased raw materials.

The resin composition according to the invention comprises a compound (d) according to formula (1). Such compounds can be commercially obtained from for example TCI Europe and can be prepared with the method as described for example by Gary M. Ksander, John E. McMurry, and Mark Johnson, “A Method for the Synthesis of Unsaturated Carbonyl Compounds” in J. Org. Chem. 1977, vol. 42, issue 7, pages 1180-1185, or by Mitsuru Ueda and Masami Takahasi, “Radical-Initiated Homo- and Copolymerization of α-Methyl-γ-Butyrolactone” in J. Pol. Sci. A 1982, vol. 20, p. 2819-2828.

Preferably, n is 1 or 2. More preferably, n is 1. X is preferably 0. Preferably, R₁ and R₂ each individually represent H or CH₃. More preferably, R₁ and R₂ are both H or R₁ is H and R₂ is CH₃. In a preferred embodiment of the invention, the composition comprises a compound (d) according to formula (2)

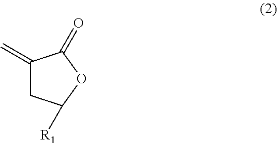

whereby R₁ is H or CH₃.

The resin composition according to the invention comprises a vinyl group containing organic compound (b) selected from the group consisting of styrene, styrene derivatives, vinyl ethers, vinyl amines, vinyl amides and mixtures of at least two of these compounds. Thus the resin composition may for example comprise, as vinyl group containing organic compound, styrene, or styrene and a vinyl ether, or two different vinyl ethers. In a preferred embodiment, the resin composition comprises styrene, a vinyl ether, a vinyl amine or vinyl amide or a mixture of at least two of these compounds as vinyl group containing organic compound. In a more preferred embodiment, the vinyl group containing organic compound is styrene, a vinyl ether, a vinyl amine or vinyl amide or a mixture of at least two of these compounds. In an even more preferred embodiment, the resin composition comprises styrene as vinyl group containing organic compound. In an even more preferred embodiment, the vinyl group containing organic compound is styrene.

Non-limited examples of styrene derivates are α-methyl styrene, vinyl toluene, 4-t.butylstyrene and 1,4-divinyl benzene. Non-limited examples of vinyl ethers are hydroxybutylvinylether, triethyleneglycoldivinylether and butanedioldivinylether. Non-limited examples of vinyl amides are N-vinylcaprolactam, N-vinylpyrrolidone and N-vinylformamide. Non-limited examples of vinyl amines are vinyl imidazole, dimethylvinylamine, N-vinylcarbazole.

The amount of unsaturated polyester (compound (a)) relative to the total amount of compounds (a), (b) and (d) is preferably from 20 to 80 wt. %, more preferably from 25 to 75 wt. %, even more preferably from 30 to 70 wt. % and most preferably from 35 to 65 wt. %. As used herein, the amount of compound (b) is the total amount of styrene, styrene derivatives, vinyl ethers, vinyl amines and vinyl amides.

The amount of compound (b) relative to the total amount of compounds (a), (b) and (d) is preferably from 10 to 50 wt. %, more preferably from 12 to 45 wt. %, even more preferably from 15 to 40 wt. % and most preferably from 18 to 35 wt. %.

The amount of compound (d) relative to the total amount of compounds (a), (b) and (d) is preferably from 5 to 60 wt. %, more preferably from 7 to 55 wt. %, even more preferably from 10 to 50 wt. % and most preferably from 12 to 45 wt. %.

The molar ratio of the amount of compound (b) to the amount of compound (d) is preferably from 0.1 to 10.

Preferably the tertiary aromatic amine has the following structure:

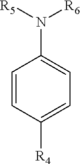

in which R4=H, C1-C5 alkyl, O(C1-C5)alkyl; R5 and R6 are independently selected from C1-C4 alkyl optionally substituted with hydroxyl or (poly) ether groups. Preferably, R4=H or CH3. Preferably R5 and/or R6 are CH3, C2H5, C2H4OH, C3H7 and CH2CH(OH)CH3.

Very suitable examples of tertiary aromatic amines are, for instance, 4-methoxy-N,N-dimethylaniline (R4=OCH3, R5 and R6=CH3), N,N-dimethylaniline (R4=H, R5 and R6=CH3), N,N-diethylaniline (R4=H, R5 and R6=C2H5), N,N-diethanolaniline (R4=H, R5 and R6=CH2CH2OH), N-methyl N-ethanol aniline (R4=H, R5=CH3, R6=CH2CH2OH), N,N-diethanoltoluidine (R4=CH3, R5 and R6=CH2CH2OH), N,N-diethanolaniline mono-methylether (R4=H, R5=CH2CH2OH, R6=CH2CH2OCH3), N,N-diethanolaniline dimethylether (R4=H, R5,R6=CH2CH2OCH3), N,N-diisopropanolaniline (R4=H, R5 and R6=CH2CH(OH)CH3), N,N-dimethyltoluidine (R4, R5 and R6=CH3), N,N-diethyltoluidine (R4=CH3, R5 and R6=C2H5), N,N-diisopropanoltoluidine DIPT (R4=CH3, R5 and R6=CH2CH(OH)CH3), N,N-diisopropanoltoluidine monomethyl ether (R4=CH3, R5=CH2CH(OCH3)CH3, R6=CH2CH(OH)CH3), N,N-diisopropanoltoluidine dimethyl ether ((R4=CH3, R5 and R6=CH2CH(OCH3)CH3), N,N-diglycidyl-4-glycidyloxyaniline (R4=OCH2CHOCH2, R5 and R6=OCH2CHOCH2 and N,N-diglycidylaniline (R4=H, R5 and R6=OCH2CHOCH2). Also N,N-ethoxylated or N,N-propoxylated anilines, respectively ethoxylated or propoxylated toluidines may suitably be used and are considered to be encompassed in the group of suitable tertiary aromatic amines. It is obvious that especially the hydroxyl functional tertiary aromatic amines may be incorporated in a polymer. Preferred aromatic amines are the anilines and the toluidines.

The amount of tertiary aromatic amine relative to the total amount of compounds (a), (b) and (d) is preferably from 0.01 to 10 wt. %, more preferably from 0.05 to 8 wt. % and even more preferably from 0.1 to 5 wt. %.

The unsaturated polyester (a) refers to a thermosetting polymer prepared by the polycondensation of at least one or more diacids and diols and which polymer contains ethylenically unsaturated carbons. The unsaturation, typically, is introduced into the polyester by condensation with unsaturated diacids, such as for example maleic (typically used as the anhydride) or fumaric acids. Examples of suitable unsaturated polyester can be found in a review article of M. Malik et al. in J.M.S.—Rev. Macromol. Chem. Phys., C40 (2&3), p. 139-165 (2000). The authors describe a classification of such resins—on the basis of their structure—in five groups:
(1) Ortho-resins: these are based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A.
(2) Iso-resins: these are prepared from isophthalic acid, maleic anhydride or fumaric acid, and glycols.
(3) Bisphenol-A-fumarates: these are based on ethoxylated bisphenol-A and fumaric acid.
(4) Chlorendics: are resins prepared from chlorine/bromine containing anhydrides or phenols in the preparation of the UP resins.

The unsaturated polyester (a) preferably comprises fumarate building blocks. The molar amount of fumarate building blocks in the unsaturated polyester (a) relative to the total molar amount of diacid building blocks in the unsaturated polyester (a) is preferably from 25% to 75%. The molar amount of fumarate building blocks in the unsaturated polyester (a) relative to the total molar amount of unsaturated dicarboxylic acid building blocks in the unsaturated polyester (a) is preferably equal to higher than 90%.

The resin composition preferably has an acid value in the range of from 0.01 to 100 mg KOH/g of resin composition, preferably in the range from 1 to 70 mg KOH/g of resin composition. In one embodiment, the resin composition has an acid value in the range of from 5 to 20. In another embodiment the resin composition has an acid value in the range of from 30 to 50. As used herein, the acid value of the resin composition is determined titrimetrically according to ISO 2114-2000.

The number-average molecular weight Mₙ of the unsaturated polyester is preferably in the range of from 500 to 200000 g/mole, more preferably from 750 to 5000 and even more preferably from 1000 to 3000 g/mole. As used herein, the number-average molecular weight Mₙ of the unsaturated polyester is determined using gel permeation chromatography according to ISO 13885-1 using polystyrene standards.

The resin composition preferably further comprises a radical inhibitor. These radical inhibitors are preferably chosen from the group of phenolic compounds, benzoquinones, hydroquinones, catechols, stable radicals and/or phenothiazines. The amount of radical inhibitor that can be added may vary within rather wide ranges, and may be chosen as a first indication of the gel time as is desired to be achieved.

Suitable examples of radical inhibitors that can be used in the resin compositions according to the invention are, for instance, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, napthoquinone, 1-oxyl-2,2,6,6-tetramethylpiperidine, 1-oxyl-2,2,6,6-tetramethylpiperidine-4-ol (a compound also referred to as TEMPOL), 1-oxyl-2,2,6,6-tetramethylpiperidine-4-one (a compound also referred to as TEMPON), 1-oxyl-2,2,6,6-tetramethyl-4-carboxyl-piperidine (a compound also referred to as 4-carboxy-TEMPO), 1-oxyl-2,2,5,5-tetramethylpyrrolidine, 1-oxyl-2,2,5,5-tetramethyl-3-carboxylpyrrolidine (also called 3-carboxy-PROXYL), galvinoxyl, aluminium-N-nitrosophenyl hydroxylamine, diethylhydroxylamine, phenothiazine and/or derivatives or combinations of any of these compounds.

Advantageously, the amount of radical inhibitor in the resin composition according to the invention (relative to the total amount of resin composition) is in the range of from 0.0001 to 10% by weight. More preferably, the amount of inhibitor in the resin composition is in the range of from 0.001 to 1% by weight. The skilled man quite easily can assess, in dependence of the type of inhibitor selected, which amount thereof leads to good results according to the invention.

The unsaturated polyester resin composition according to the invention may further comprise (in)organic filler. The amount of (in)organic filler relative to the total amount of compounds (a), (b) and (d) is preferably from 10 to 90 wt. %. Preferably, the unsaturated polyester resin composition comprises fibre as filler. Suitable fillers are aluminium trihydrate, calcium carbonate, mica, glass, microcrystalline silica, quartz, barite and/or talc. These fillers may be present in the form of sands, flours or molded objects, especially in the form of fibers or spheres. Examples of fibres are glass fibres and carbon fibres.

The present invention further relates to a process for radically curing a resin composition according to the invention whereby the curing is effected in the presence of a peranhydride. The amount of peranhydride relative to the total amount of compounds (a), (b) and (d) is preferably from 0.01 to 30 wt. %, more preferably from 0.05-20 wt. % and even more preferably from 0.1-15 wt. %. The molar amount of peranhydride relative to the molar amount of tertiary aromatic amine (compound (c)) is preferably from 0.1 to 10. The curing is effected preferably at a temperature in the range of from −20 to +150° C., more preferably in the range of from −20 to +100° C. and even more preferably in the range of from −20 to +40° C.

The present invention further relates to a multicomponent system comprising (a) an unsaturated polyester, (b) styrene, a styrene derivative, a vinyl ether, a vinyl amine or vinyl amide or a mixture of at least two of these compounds as a vinyl group containing organic compound (b), (c) a tertiary aromatic amine, a peranhydride and (d) a compound according to formula (1) as reactive diluent

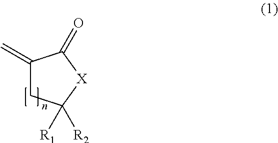

whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain or attached to a polymer chain. Preferred compounds (a), (b), (c) and (d) as well as the amounts are as described above. The system may further comprise additional compounds in amounts as described above.

The use of the multicomponent system according to the invention requires mixing of at least the compounds (a), (b), (c) and (d) together with the peranhydride to obtain a cured network. As used herein, multicomponent systems means a system with at least two spatially separated components whereby the peranhydride is present in one component that does not comprise radical copolymerizable compounds including compounds (a), (b) and (d) in order to prevent premature radical copolymerization of the compounds (a), (b) and (d) prior to the use of the multicomponent system to obtain the cured network. At the moment that the radically copolymerization of the compounds (a), (b) and (d) is desired, at least a peranhydride is added to this composition. Preferably, said adding is done by mixing the peranhydride into the composition comprising compounds (a), (b) and (d). The multicomponent system according to the invention comprises at least two components.

In one embodiment, the multicomponent system comprises at least three components I, II and III, whereby component I consists of a composition comprising compounds (a), (b) and (d), component II consists of a composition comprising compound (c) and component III comprises the peranhydride.

In another embodiment, the system comprises at least two components I and II, whereby component I consists of a composition comprising compounds (a), (b), (c) and (d) and component II comprises the peranhydride.

The present invention further relates to a two component system consisting of a first component I and a second component II, the first component I is a resin composition as defined above and the second component II comprises a peranhydride.

Very suitable examples of peranhydrides are, for instance, dibenzoyl peroxide and dilauroyl peroxide.

The present invention further relates to cured objects obtained by curing the resin composition according to the invention with a peranhydride or obtained by the process according to the invention or obtained by mixing the compounds of the multicomponent system as described above.

The present invention further relates to the use of such a cured structural part in automotive, boats, chemical anchoring, roofing, construction, containers, relining, pipes, tanks, flooring or windmill blades.

The invention is now demonstrated by means of a series of examples and comparative examples. All examples are supportive of the scope of claims. The invention, however, is not restricted to the specific embodiments as shown in the examples.

### Gel Timer Experiments

In some of the Examples and Comparative Experiments presented hereinafter, it is mentioned that curing was monitored by means of standard gel time equipment. This is intended to mean that both the gel time (T_{gel} or T_{25->35° C.}) and peak time (Tₚₑₐₖ or T_{25->peak}) and peak temperature were determined by exotherm measurements according to the method of DIN 16945 when curing the resin with the peroxides as indicated in the Examples and Comparative Examples. The equipment used therefore was a Soform gel timer, with a Peakpro software package and National Instruments hardware; the waterbath and thermostat used were respectively Haake W26, and Haake DL30.

### EXAMPLE 1 AND COMPARATIVE EXPERIMENTS A1-A4

To 34.1 g Daron 41 (a hydroxyl functional unsaturated polyester in styrene, commercially available from DSM Composite Resins) was added 10.9 of various reactive diluents (see Table 1). The viscosity of the mixture was determined (Brookfield CAP1000, cone 1, 25 C, 750 rpm).

To these mixtures 840 mg NL-64-10P (a 10% solution of N,N-dimethylaniline, Akzo Nobel) was added and the mixtures were stirred for 5 minutes.

Next 840 mg Perkadox CH50L (50% dibenzoyl peroxide in phthalates) was added. The curing was monitored using the standard geltimer equipment. 12 g of such a mixture was used to make a 4 mm casting in a small alumina dish in order to determine the barcol hardness values and enabling the curing in thinner layers. Barcol hardness was measured according to DIN EN 59.

The results are shown in table 1.

MMA=methyl methacrylate
HPMA=2-hydroxy propyl methacrylate
LMA=Lauryl methacrylate
MBL=α-methylene butyrolactone

TABLE 1

| | | Boiling | | | | | Barcol | Barcol |
|---|---|---|---|---|---|---|---|---|
| | | point (° C./ | Gel time | Peak | Peak | Viscosity | hardness | hardness |
| | Diluent | mmHg) | (min) | time (min) | temp (° C.) | (Pa · s) | top | (bottom) |
| 1 | MBL | 88/12 | 24.2 | 33.1 | 156 | 0.051 | 30 | 45 |
| A1 | Styrene | 145/760 | 14.2 | 23.1 | 131 | 0.074 | 10 | 18 |
| A2 | MMA | 100/760 | 20.7 | 25.8 | 166 | 0.1 | Tacky | 40 |
| A3 | HPMA | 57/0.5 | 14.2 | 18.6 | 144 | 0.127 | Tacky | 30 |
| A4 | LMA | 142/4 | Not | | | | | |
| | | | miscible | | | | | |

This example together with the comparative experiments clearly shows that by curing formulations according to the invention, a low volatility as indicated by the high boiling point, a good reactivity (as indicated by the gel time), a good through curing (as indicated by both the peak temperature as well as the barcol hardness at the bottom of the cup) and a good curing in air, as indicated by the barcol of the air exposed surface (top), can be obtained.

The castings of example 1 and comparative experiment A1 were subjected to DMA analysis according to ASTM D5026 at a frequency of 1 Hz.

The results were as follows:

### Example 1: Modulus 23° C.: 3167 Mpa; T_{g} 97° C.

### Comp A1: Modulus 23° C.: 2742 Mpa; T_{g} 76° C.

Both data indicate that using the formulation according to the invention a better cross-linked network has been formed.

### COMPARATIVE EXPERIMENT A5

Styrene was evaporated from Daron 41, thereafter MBL was added. IR analysis showed that no curing of the unsaturated polyester was observed and that only polymerization of MBL has taken place. From this comparative experiment it can be concluded that a vinyl group containing compound is needed to obtain a cured network. Comparing example 1 with comparative experiment A1 and A5 shows that an unexpected synergistic effect on mechanical properties can be obtained when using the formulation according to the invention:

In comparative experiment A1, in which only styrene is present as reactive diluent, a cured network is obtained with a certain barcol hardness;

In comparative experiment A5, in which only MBL is present as reactive diluent, no cured network at all was detected by IR analysis;

In example 1, in which MBL and styrene are present as reactive diluent, a cured network with barcol hardness that is significantly higher than in comparative experiment A1 is obtained.

### EXAMPLES 2-4 AND COMPARATIVE EXPERIMENTS B1-B12

To a mixture of 33.1 g Palatal P5-01 (an unsaturated polyester resin in styrene, DSM Composite Resins) and 11.9 g MBL in a plastic beaker was added 850 mg of various amines and 850 mg of various peroxides in order to cure the mixtures in the beaker. The cure results are depicted in table 2.

TABLE 2

| | Amine | Peroxide | Type | |
|---|---|---|---|---|
| Example 2 | N,N-Diethyl | Perkadox 20 | Aromatic | Cure |
| | aniline | S | peranhydride | |
| Example 3 | N,N-dimethyl | Perkadox CH | Aromatic | Cure |
| | aniline | 50L | peranhydride | |
| Example 4 | DIPT (N,N- | Laurox S | Aliphatic | Cure |
| | diisopropanol | | peranhydride | |
| | Toluidine) | | | |
| Comp exp B1 | N,N-dimethyl | Butanox M50 | Ketal | No cure |
| | aniline | | peroxide | |
| Comp exp B2 | N,N-dimethyl | Trigonox C | Perester | No cure |
| | aniline | | | |
| Comp exp B3 | N,N-dimethyl | Trigonox 117 | Percarbonate | No cure |
| | aniline | | | |
| Comp exp B4 | N,N-dimethyl | Trigonox B | Perether | No cure |
| | aniline | | | |
| Comp exp B5 | N,N-dimethyl | Trigonox 44B | Ketal | No cure |
| | aniline | | peroxide | |
| Comp exp B6 | N,N-dimethyl | Trigonox AW | Hydro- | No cure |
| | aniline | 70 | peroxide | |
| Comp exp B7 | 2,3 dimethyl | Perkadox CH | Aromatic | No cure |
| | aniline | 50L | peranhydride | |
| Comp exp B8 | 2,6 dimethyl | Perkadox CH | Aromatic | No cure |
| | aniline | 50L | peranhydride | |
| Comp exp B9 | Aniline | Perkadox CH | Aromatic | No cure |
| | | 50L | peranhydride | |
| Comp exp B10 | Triethyl | Perkadox CH | Aromatic | No cure |
| | amine | 50L | peranhydride | |
| Comp exp B11 | Benzyl | Perkadox CH | Aromatic | No cure |
| | trimethyl | 50L | peranhydride | |
| | ammonium | | | |
| | chloride | | | |
| Comp exp B12 | Butyl amine | Perkadox CH | Aromatic | No cure |
| | | 50L | peranhydride | |

These examples and the comparative experiments clearly show that a good and efficient curing of a formulation according to the invention can be obtained when using a peranhydride and a tertiary aromatic amine.

### EXAMPLE 5 AND COMPARATIVE EXPERIMENT C

To a mixture of 33.1 g Palatal P5-01 and 11.9 g MBL or styrene was added 850 mg N,N-dimethyl aniline. The viscosity of the mixtures were determined (Brookfield CAP 1000, 25 C 750 rpm, cone 2). To these mixtures 840 mg Perkadox CH 50 L was added. 12 g of the mixture was poured in an Al dish for the determination of Barcol hardness. Furthermore of 25 g the curing was monitored in the standard gel timer equipment. The results are shown in table 3.

TABLE 3

| | | | Gel | Peak | | | Barcol | Barcol |
|---|---|---|---|---|---|---|---|---|
| | | | time | time | Peak | Viscosity | hardness | hardness |
| | diluent | | (min) | (min) | temp (C.) | (Pa · s) | top | (bottom) |
| 5 | MBL | N,N- | 2.6 | 9.3 | 132 | 0.087 | Slight | 20 |
| | | dimethyl | | | | | tack | |
| | | aniline | | | | | | |
| C | Sty | N,N- | 3.1 | 9.2 | 125 | 0.185 | Tacky | 0 |
| | | dimethyl | | | | | | |
| | | aniline | | | | | | |

This example combined with the comparative experiment again demonstrated that a good cutting power (indicated by the lower viscosity), a low volatility, a high reactivity (indicated by the gel time data), a reasonable surface cure in air and a good mechanical integrity (indicated by the barcol at the bottom) can only be achieved according to the invention.

1. Unsaturated polyester resin composition comprising (a) an unsaturated polyester, (b) a vinyl group containing organic compound as reactive diluent and (c) a tertiary aromatic amine, wherein the resin composition further comprises (d) a compound according to formula (1) as reactive diluent 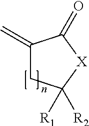
whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain and/or attached to a polymer chain,
and the resin composition comprises, as vinyl group containing organic compound (b), styrene, a styrene derivative, a vinyl ether, a vinyl amine, a vinyl amide or a mixture of at least two of these compounds.

2. Unsaturated polyester resin composition according to claim 1, characterized in that compound (d) is according to formula (2). 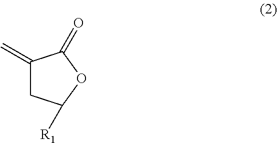
whereby R₁ is H or CH₃.

3. Unsaturated polyester resin composition according to claim 1, wherein the resin composition comprises styrene as vinyl group containing organic compound (b).

4. Unsaturated polyester resin composition according to claim 1, wherein the amount of unsaturated polyester (compound (a)) relative to the total amount of compounds (a), (b) and (d) is from 20 to 80 wt. %, whereby the amount of compound (b) is the total amount of styrene, styrene derivatives, vinyl ethers, vinyl amines and vinyl amides.

5. Unsaturated polyester resin composition according to claim 1, wherein the amount of compound (b) relative to the total amount of compounds (a), (b) and (d) is from 10 to 50 wt. %, whereby the amount of compound (b) is the total amount of styrene, styrene derivatives, vinyl ethers, vinyl amines and vinyl amides.

6. Unsaturated polyester resin composition according to claim 1, wherein the amount of compound (d) relative to the total amount of compounds (a), (b) and (d) is from 5 to 60 wt. %.

7. Unsaturated polyester resin composition according to claim 1, wherein the molar ratio of the amount of compound (b) to the amount of compound (d) is from 0.1 to 10.

8. Unsaturated polyester resin composition according to claim 1, wherein the amount of tertiary aromatic amine relative to the total amount of compounds (a), (b) and (d) is from 0.01 to 10 wt. %.

9. Unsaturated polyester resin composition according to claim 1, wherein the unsaturated polyester comprises fumarate building blocks.

10. Unsaturated polyester resin composition according to claim 1, wherein the unsaturated polyester (a) comprises fumarate building blocks and the molar amount of fumarate building blocks in the unsaturated polyester (a) relative to the total molar amount of diacid building blocks in the unsaturated polyester (a) is from 25% to 75%.

11. Process for radically curing a resin composition according to claim 1, comprising in that the curing in the presence of a peranhydride.

12. Process according to claim 11, wherein the amount of peranhydride relative to the total amount of compounds (a), (b) and (d) is from 0.01 to 30 wt. %, or optionally from 0.05-20 wt. % or optionally from 0.1-15 wt. %.

13. Process according to claim 12, wherein the molar amount of peranhydride relative to the molar amount of tertiary aromatic amine (compound (c)) is from 0.1 to 10.

14. Process according to comprising curing at a temperature in a range of from −20 to +150° C., optionally in a range of from −20 to +100° C. or optionally in a range of from −20 to +40° C.

15. Cured object obtained by curing the resin composition according to claim 1 with a peranhydride.

16. A cured object of claim 15 capable of being used in automotive, boats, chemical anchoring, roofing, construction, containers, relining, pipes, tanks, flooring and/or windmill blades.
